(19) United States
(12) Patent Application Publication
(10) Pub. No.: US 2013/0166045 A1
(43) Pub. Date: Jun. 27, 2013

(54) Command Interface

(71) Applicants: Andrew Sherlock, Edinburgh (GB); Frank Mill, Edinburgh (GB)

(72) Inventors: Andrew Sherlock, Edinburgh (GB); Frank Mill, Edinburgh (GB)

(73) Assignee: The University Court of the University of Edinburgh, Edinburgh (GB)

(21) Appl. No.: 13/698,809

(22) PCT Filed: May 12, 2011
(86) PCT No.: PCT/GB11/50912

§ 371 Date: Mar. 5, 2013

(30) Foreign Application Priority Data
May 18, 2010 (GB) 1008228.7

(51) Int. Cl. G05B 19/00

(52) U.S. Cl. CPC G05B 19/00
USPC 700/83

(57) ABSTRACT

A command interface of a machine including a plurality of different control elements each of which generates a different control command when actuated by a user, wherein the plurality of control elements are arranged for actuation by a user and are categorized into different groups including: a first group of control elements including control elements that are most similar, according to a first similarity criterion, to a target control element specified by the user in a prior request; and a second group of control elements including a first additional control element that is dissimilar, according to the first similarity criterion, to the target control element specified by the user in the prior request, and that, when actuated by a user, specifies in a new request the first additional control element as a target control element.

### FIELD OF THE INVENTION

Embodiments of the present invention relate to a command interface.

### BACKGROUND TO THE INVENTION

Machines are typically controlled via a command interface (human machine interface). A command interface may, for example, be provided using mechanical technology as a series of levers or switches or using computer technology as a graphical user interface having a number of selectable icons.

A problem arises when a machine has a large number of possible commands. It may be difficult to arrange the commands so that a user has easy access to a desired command without overburdening a user with simultaneous options.

As an example, a problem arises if a user of a computer wishes to locate and access a file that defines a particular three dimensional model. This problem may, for example, arise in an engineering design company where a draftsman wishes to locate and access an existing drawing that he may or may not know exists. This problem may, for example, arise in a warehouse where a warehouseman wishes to use a catalogue to locate and access an existing warehoused item.

### BRIEF DESCRIPTION OF THE INVENTION

According to various embodiments of the invention there is provided a command interface of a machine comprising: a plurality of different control elements each of which generates a different control command when actuated by a user, wherein the plurality of control elements are arranged for actuation by a user and are categorized into different groups including: a first group of control elements comprising control elements that are most similar, according to a first similarity criterion, to a target control element specified by the user in a prior request; and a second group of control elements comprising a first additional control element that is dissimilar, according to the first similarity criterion, to the target control element specified by the user in the prior request, and that, when actuated by a user, specifies in a new request the first additional control element as a target control element.

According to various embodiments of the invention there is provided a graphical user interface comprising: a plurality of different control elements each of which generates a different control command when actuated by a user and each of which is mapped to a different data structure defining a three dimensional model having a shape, each control element being thereby associated with a shape, wherein the plurality of control elements are arranged for actuation by a user and are categorized into different groups including: a first group of control elements comprising control elements that are associated with shapes that are most similar, according to a first similarity criterion, to a shape specified by the user in a prior request, and a second group of control elements comprising a first additional control element that is associated with a shape that is dissimilar, according to the first similarity criterion, to the shape specified by the user in the prior request, and that, when actuated by a user, specifies in a new request the shape associated with the first additional control element.

According to various embodiments of the invention there is provided a method for controlling a machine comprising: presenting a first group of control elements for actuation by a user and comprising control elements that are most similar, according to a first similarity criterion, to a target; presenting a second group of control elements for actuation by a user and comprising a first additional control element that is dissimilar, according to the first similarity criterion, to the target; detecting actuation of the first additional control element; presenting a replacement first group of control elements for actuation by a user and comprising control elements that are most similar, according to a first similarity criterion, to the first additional control element; and presenting a replacement second group of control elements for actuation by a user and comprising a replacement first additional control element that is dissimilar, according to the first similarity criterion, to the first additional control element.

According to various embodiments of the invention there is provided a method for controlling a machine comprising: presenting a first group of control elements for actuation by a user and comprising control elements that are associated with shapes that are most similar, according to a first similarity criterion, to a target shape; presenting a second group of control elements for actuation by a user and comprising a first additional control element that is associated with a shape that is dissimilar, according to the first similarity criterion, to the target shape; detecting actuation of the first additional control element; presenting a replacement first group of control elements for actuation by a user and comprising control elements that are associated with shapes that are most similar, according to the first similarity criterion, to a shape associated with the first additional control element; and presenting a replacement second group of control elements for actuation by a user and comprising a replacement first additional control element that is associated with a shape that is dissimilar, according to the first similarity criterion, to the shape associated with the first additional control element.

According to various embodiments of the invention there is provided a command interface of a machine comprising: a plurality of different control elements each of which generates a different control command when actuated by a user, wherein the plurality of control elements are arranged for actuation by a user and are categorized into different groups including: a first group of control elements comprising control elements that are most similar, according to a first similarity criterion, to a target specified by the user; and a second group of control elements comprising a first additional control element that is dissimilar, according to the first similarity criterion, to the target specified by the user, and that, when actuated by a user, generates a new categorization of control elements into groups including: a third group of control elements comprising control elements that are most similar, according to the first similarity criterion, to the first additional control element actuated by the user; and a fourth group of control elements comprising a further additional control element that is dissimilar, according to the first similarity criterion, to the first additional control element actuated by the user.

According to various embodiments of the invention there is provided an apparatus or computer program comprising: a command interface of a machine comprising: a plurality of different control elements each of which generates a different control command when actuated by a user, wherein the plurality of control elements are arranged for actuation by a user and are categorized into different groups including: a first group of control elements comprising control elements that are most similar, according to a first similarity criterion, to a target control element specified by the user in a prior request; and a second group of control elements comprising a first additional control element that is dissimilar, according to the first similarity criterion, to the target control element specified by the user in the prior request, and that, when actuated by a user, specifies in a new request the first additional control element as a target control element.

### BRIEF DESCRIPTION OF THE DRAWINGS

For a better understanding of the present invention reference will now be made by way of example only to the accompanying drawings in which:

FIG. 1 illustrates an apparatus;

FIGS. 2A, 2B and 2C are schematic illustrations of a simplified parameter space;

FIG. 3 illustrates a GUI in which control elements are arranged in an advantageous manner; and

FIG. 4 schematically illustrates a process by which a collection of data structures is processed to provide a command interface.

### DETAILED DESCRIPTION OF EMBODIMENTS OF THE INVENTION

Embodiments of the invention relate to a control or command interface 2 of a machine 10 that provides more efficient control of the operation of the machine.

The command interface 2 comprises a plurality of different control elements 12 each of which generates a different control command when actuated by a user.

The plurality of control elements 12 are arranged for actuation by a user and are categorized into different groups 14.

A first group 14A of control elements 12 consists of control elements that are most similar, according to a first similarity criterion 22, to a control element 20 specified by the user in a request.

A second group 14B of control elements 12 consists of additional control elements including a first additional control element 16A that is dissimilar, according to the first similarity criterion 22, to the type of control element 20 specified by the user in the request, and that specifies in a first additional request the first additional control element 16A when actuated by a user.

The second group 14B of control elements 12 comprises a second additional control element 16B that is dissimilar, according to the first similarity criterion 22, to the control element 20 specified by the user in the request, and that specifies in a second additional request the second additional control element 16B when actuated by a user.

The first group 14A of control elements 12 may be the most easily accessible and the second group 14B of control elements 12 may be less easily accessible.

The machine 10 may be a computer memory access controller (e.g. a microprocessor). In this scenario, a particular control command may be a memory access command that enables a particular data structure 3 to be accessed and returned by the computer memory 8.

A particular control command may also or alternatively be a rendering command that controls an output device, such as a display 4, to render an image using a data structure 3 so that it may be, for example, viewed, edited etc.

In the following description of one embodiment of the invention, the control elements 12 are selectable icons on a computer display. However, it should be appreciated that control elements 12 may, in other embodiments, be physical levers, switches etc that are moved into and out of range of a user. Thus, although a computer and program for a computer may be useful tools in the described embodiment of the invention, they are not essential elements of every embodiment of the invention although they may be essential elements of some embodiments.

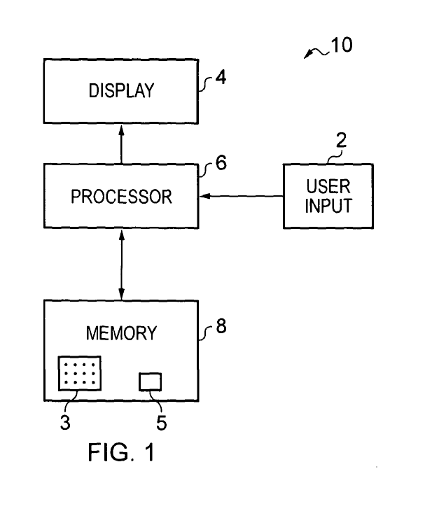

FIG. 1 illustrates an apparatus 10 that provides a graphical user interface that enables efficient control of the apparatus 10. In particular, it provides an efficient mechanism by which a user can control the apparatus 10 to access a desired data structure 3 in a memory 8 and process the accessed data structure 3 to render an image on a display 4.

The apparatus 10, in this example, is a computer. It comprises a processor 6, a display 4, a memory 8 and a user input device 2 such as a touch screen or a pointer device such as a computer mouse or a keyboard etc.

The processor 6 is arranged to provide commands to the display 4 and to receive commands from the user input device 2. The processor 6 is also arranged to read from and write to the computer memory 8.

The memory 8 comprises a plurality of data structures 3 such as application files and also a computer program 5.

The data structures 3 comprise information that may be parameterized as described later.

In the described implementation, the data structures 3 comprise information that is usable by the processor 6 to render a three dimensional image on the display 4. The data structures 3 may, for example, be files that define three dimensional models for a computer aided design software package.

A data structure, in this example, defines a three dimensional body. The shape of a three dimensional body may be defined by the values the shape has for each of a number of different parameters. The parameters form a multi-dimensional space and a particular shape occupies a point in that space.

Examples of suitable parameters are: body volume (V), body surface area (A), compactness (V²/A³).

Other parameters may be generated from the bounding box for the body. The bounding box is the smallest cuboid that can be placed around the body. Parameters generated may be the three dimensions of the bounding cuboid and aspect ratios for the bounding cuboid.

Other parameters may be generated from the convex hull for the body. The convex hull is the minimum convex polygon that surrounds the body. The convex hull does not take account of internal cavities. Parameters generated may be: convex hull volume (CHV), convex hull surface area (CHSA), packing ratio (CHV/V), crinkliness (CHSA/A).

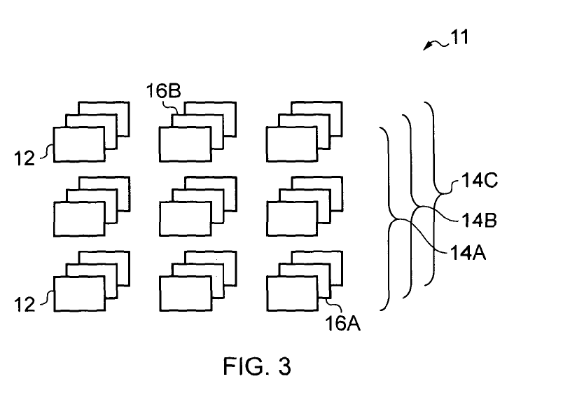

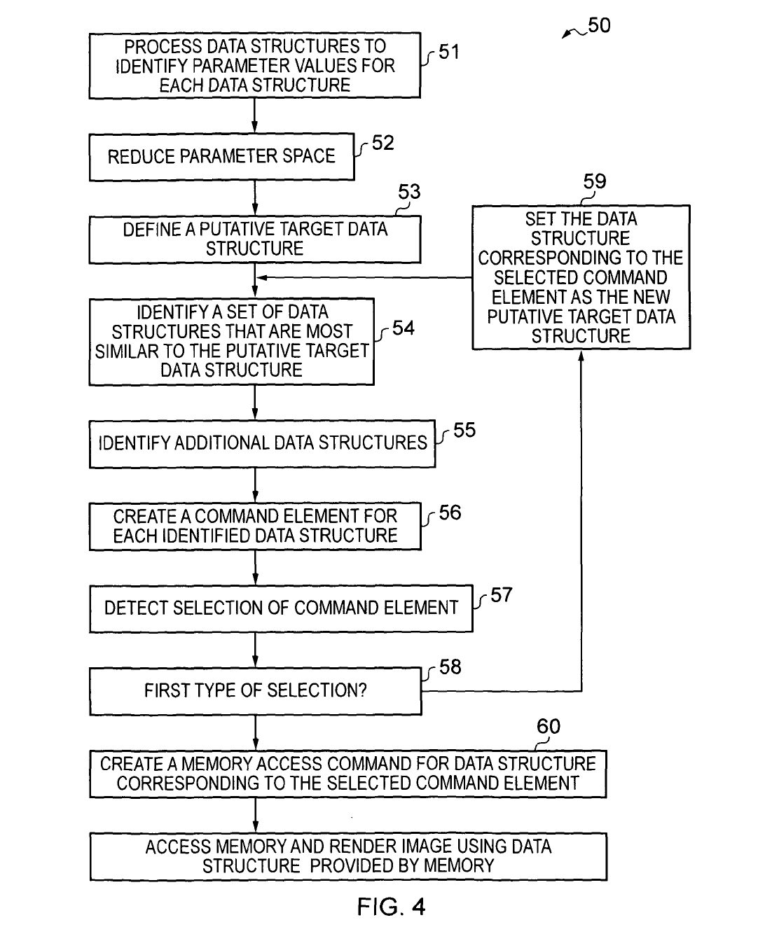

Reference is now made to FIG. 4, which schematically illustrates a process 50 by which a collection of data structures 3 is processed to provide a command interface, such as the graphical user interface (GUI) 11 illustrated in FIG. 3 which includes organized control elements 12 for controlling access to the memory 8 and rendering of an image.

The process is illustrated as a series of blocks. The blocks may be steps in a method or sections of code in the computer program 5.

The computer program comprises computer program instructions or code that controls the operation of the apparatus 10 when loaded into the processor 6. The computer program instructions 5 provide the logic and routines that enables the electronic device to perform the methods illustrated in FIG. 4.

The computer program instructions may arrive at the apparatus 10 via an electromagnetic carrier signal or be copied from a physical entity such as a computer program product, a memory device or a record medium such as a CD-ROM or DVD.

At block 51, the collection of data structures 3 are processed to identify parameter values i.e. to find the location of each data structure 3 in the multi-dimensional parameter space. This populates the parameter space.

Next at block 52, the parameter space is rationalized to define the operational parameters. This is an optional step.

The parameters that best describe the variance between the collection of data structures 3 are identified. These operational parameters define a sub-space of the original parameter space.

The reduced parameter set may be determined using principal components analysis (PCA). PCA is a linear transformation that transforms the original basis of parameters to a new basis of parameters in which the greatest variance in the parameter values is along a first coordinate, the second greatest variance on a second coordinate etc.

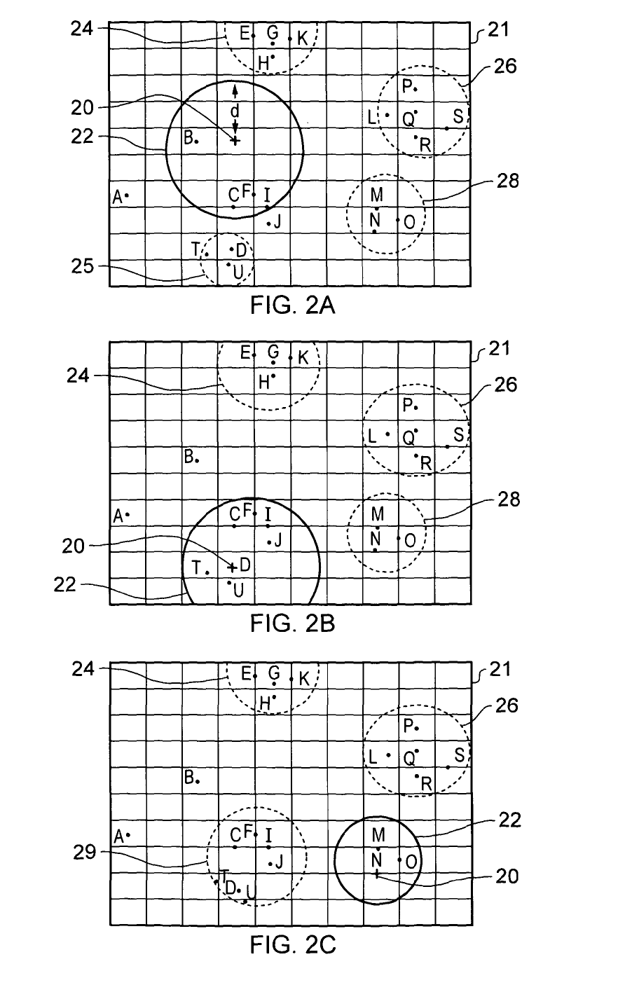

FIGS. 2A, 2B and 2C are schematic illustrations of a simplified parameter space 21 (before or after rationalization) that uses only two parameters. Each data structure 3 is represented as a capital letter. The (x,y) location of the letter in the parameter space indicates the parameter values (x,y) for the respective two parameters.

As will be described later at least some of the data structures illustrated will have corresponding control elements 12 in the GUI 11 and all of the data structures could have corresponding control elements 12 in the GUI 11. The capital letters in FIGS. 2A, 2B and 2C that label different data structures 3 may also therefore be considered to label different control elements for accessing the respective data structures 3. Consequently when reference is made in the following to ‘similarity’ it may be considered as similarity between data structures or similarity between control elements.

Next at block 53, the user defines a putative target 20. The target 20 may be considered to be a data structure 3 or its corresponding control element 12. The putative target defines a point or region in the parameter space 21.

The putative target 20 may, for example, be defined via a number of different types of requests. In one type of request, a search query interface is used by a user to explicitly input parameter values for a desired shape. In another type of request, the user may sketch a picture of the desired shape which is then processed to determine the values of the operational parameters for that shape. In a further type of request, the putative target 20 may be defined by user selection of a control element 12 (described below).

Next at block 54, a ‘similar’ set S of data structures (control elements) is identified. This is the set 22 of data structures (control elements) that are most similar (least different) to the putative target 20 taking account of all the operational parameters.

If there are a basis of operational parameters {pᵢ}where i=0, 1, 2 . . . N, then the value of each operational parameter Pᵢ, for the data structures in the set S, is similar to the value Qᵢ of the same parameter for the putative target 20.

‘Similar’ in this context means that the value Pᵢ of a parameter pᵢ is within threshold of the value Qᵢ of that parameter e.g. Qᵢ−aᵢ<Pᵢ<Qᵢ+bᵢ, where aᵢ and bᵢ represent the respective lower and upper relative thresholds.

The thresholds may be explicitly defined by, for example, specifying an explicit threshold value for aᵢ and bᵢ or an explicit general threshold value for all parameters. A threshold may, for example, be specified as a % of the corresponding putative parameter value Q. This sets a tolerance for similarity. The values aᵢ and bᵢ may be the same or different. The values aᵢ may be parameter dependent or they may be the same for every i. The absolute threshold values Qᵢ−aᵢ, Qᵢ+bᵢ define a volume 22 in the parameters space 21 within which the members of the set S and the putative target 20 lie.

The thresholds may be implicitly defined by, for example, specifying a size M for the set S and dynamically adjusting the threshold values for each parameter or a general threshold value for all parameters until the required set size is obtained.

A sum of the difference, for each parameter pᵢ, between a candidate value Pᵢ and the putative target value Qᵢ may be calculated. The M lowest scoring candidates may be selected for the set S. The sum may weight each parameter equally or, alternatively, unequally.

The implicitly defined thresholds for each parameter pᵢ define a volume 22 in the parameter space 21.

Referring to FIGS. 2A, 2B and 2C a simplified parameter space 21 is illustrated. In each of the figures the volume 22 surrounding the putative target 20 defines the set S. The set S consists of the data structures (control elements) that are enclosed by that volume. In FIG. 2A the set S consists of data structures (control elements) B, C, F, I. In FIG. 2B the set S consists of C, F, I, J. In FIG. 2C the set S consists of M, N, O.

Next at block 55, additional data structures (control elements) are identified using a different criterion than that used at block 54. That is the additional data structures (control elements) are not identified by similarity to the putative target taking account of all the operational parameters.

In one embodiment, some or all of the additional data structures (control elements) may be identified by similarity to the putative target but only taking account of a sub-set of all the operational parameters. Thus in the example of FIG. 2A, the data structure (control element) R may be an additional data structure (control element) as it lies outside the volume 22 but has a similar ‘y-coordinate’ value and the data structure (control element) D may be an additional data structure (control element) because it lies outside the volume 22 but has a similar ‘x-coordinate’ value.

In another embodiment, some or all of the additional data structures (control elements) may be identified by popularity i.e. according to the number of times or frequency of use.

In another embodiment, some or all of the additional data structures (control elements) may be identified by clustering the out-liner or ‘dissimilar’ data structures (control elements) i.e. those outside the volume 22.

A suitable clustering algorithm is used. These are well known to persons skilled in the art and include, for example, the K-means algorithm. The clustering algorithm may be applied to all the data structures (control elements) not included in the set S or alternatively to a certain sub-set of those data structures (control elements) such as the M ‘nearest’.

FIG. 2A labels a first cluster 24 comprising the data structures (control elements) E, G, K, H, a second cluster 26 comprising the data structures (control elements) P, Q, R, S, a third cluster 28 comprising the data structures (control elements) M, N, O, and a fourth cluster 25 comprising the data structures (control elements) T, D, U. It should be noted that the data structures A, J occupy a volume in the parameter space that is outside both the boundary 22 of the set S and also outside the boundaries of the clusters 24, 25, 26, 28.

An example data structure (control element) is then selected from each of the clusters to be an additional data structure (control element) that represents an instance in the class of data structures (control elements) defined by that cluster.

An example data structure (control element) may be selected based on popularity (e.g. amount or frequency of use), or based on the time elapsed since last use, or based on the data structure (control element) that is the closest match to the target in all or some of the operational parameters or selected because it is a defined archetype.

It should be appreciated that the parameter space 21 may be considered as three separate volumes one inside the other. The inner volume 22 defines the set S of most similar data structures (control elements). The outer volume defines dissimilar data structures (control elements) that are not similar to the putative target using the criterion used to generate the set S. The additional data structures (control elements) preferably populate this outer volume. These additional data structures (control elements) may be considered to represent candidate putative targets which when they become the actual putative target enable the position of the inner volume 22 to be centred on them. For example, in FIG. 2B the putative target is the data structure (control element) D which was an additional data structure (control element) in FIG. 2A, representing the fourth cluster 25.

The intermediate volume defines slightly similar data structures (control elements) such as A, J in FIG. 2A. These data structures (control elements) are ones that are not similar enough to the putative target to be likely matches but also not suitable candidates for repositioning the inner volume 22.

At block 55 a control element 12 is provided for each identified data structure i.e. there is an actuable control element for each data structure (control element) in the set S and also for each additional data structure (control element). Each actuable control element is therefore mapped to a particular data structure.

If the control element 12 is actuated in a first manner (e.g. single click of a computer mouse if the control element is a computer icon) the mapped data structure is set as the new putative target data structure as illustrated in blocks 57, 58 and 59 in FIG. 4. It may alternatively be considered that the actuated control element is set as the new target 20 because of the one-to-one mapping between data structure and control element.

FIG. 2A illustrates, in parameter space 21, an initial configuration in which the putative target 20 is defined by a user search query and does not exactly correspond to an existing data structure (control element).

The user then actuates, in a first manner, a control element 12 associated with a mapping D between control element and data structure. The consequence of this actuation is illustrated in parameter space 21 by FIG. 2B. The set S of similar data structures (control elements) is now defined with reference to D and new additional data structures (control elements) are determined. This results in a change to the GUI 11 and the identity and arrangement of control elements 12.

The user then actuates, in a first manner, the control element 12 mapped to the data structure N. The consequence of this actuation is illustrated in parameter space 21 by FIG. 2C. The set S of similar data structures is now defined with reference to data structure N and new additional data structures are determined. This results in a change to the GUI 11 and the identity and arrangement of control elements.

If the control element 12 is actuated in a second manner (e.g. double click of a computer mouse if the control element is a computer icon) a memory access command is created to access the mapped data structure (block 60), the memory is accessed using the memory access command and an image is rendered for editing using the accessed data structure (block 61).

FIG. 3 illustrates a GUI 11 in which the control elements are arranged in an advantageous manner. The selectable control elements 12 mapped to the set S of data structures are arranged as a first group 14A. The selectable control elements 12 mapped to the additional data structures are arranged as a second group 14B.

The first group 14A of control elements may be arranged in a specific order. For example, the control element 12 that is mapped to the data structure that is most similar to the putative target data structure may be positioned centrally. The distance of the other control elements 12 from the central control element may be dependent upon the similarity of the data structure that is mapped to that control element and the putative target data structure. The most similar are close and the less similar are further away.

The control elements 12 may comprise ‘thumbnail’ images of the image or rotating 3D rendered image that would be produced if the data structure 3 mapped to that control element were accessed for editing. A control element 12 may thus give a visual indication of the values of the parameters for the data structure 3 it is mapped to.

In the example GUI 11, the first group 14A of control elements 12 is arranged as a regular m×n array and the second group 14B of control elements 12 is also arranged as a regular m×n array. The arrays are positioned so that the second group 14A is behind but slightly offset the first group 14A giving the impression of a three dimensional stack of arrays. The user may be able to navigate through this arrangement.

Although embodiments of the present invention have been described in the preceding paragraphs with reference to various examples, it should be appreciated that modifications to the examples given can be made without departing from the scope of the invention as claimed.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. A command interface of a machine comprising:
a plurality of different control elements each of which generates a different control command when actuated by a user, wherein
the plurality of control elements are arranged for actuation by a user and are categorized into different groups including:
a first group of control elements comprising control elements that are most similar, according to a first similarity criterion, to a target control element specified by the user in a prior request; and
a second group of control elements comprising a first additional control element that is dissimilar, according to the first similarity criterion, to the target control element specified by the user in the prior request, and that, when actuated by a user, specifies in a new request the first additional control element as a target control element.

2. A command interface as claimed in claim 1 wherein the second group of control elements further comprises a second additional control element that is dissimilar, according to the first similarity criterion, to the control element specified by the user in the prior request, and that, when actuated by a user, specifies in a new request the second additional control element.

3. A command interface as claimed in claim 1, wherein the first group of control elements are more easily accessed than the second group of control elements.

4. A command interface as claimed in claim 1, wherein the control elements are mapped to respective data structures.

5. A command interface as claimed in claim 4, wherein a data structure, defines a model having a shape.

6. A command interface as claimed in claim 5, wherein the shape is parameterized, and a control element is describable by values of the parameters for the model shape defined by the data structure mapped to said control element.

7. A command interface as claimed in claim 6, wherein the similarity of control elements is determined by comparing the similarity of their describing parameter values.

8. A command interface as claimed in claim 7, wherein the first group of control elements are those control elements that have describing parameter values that are within a threshold of the describing parameter values of the target control element.

9. A command interface as claimed in claim in claim 8, wherein the threshold is explicitly defined.

10. (canceled)

11. A command interface as claimed in claim 7, wherein at least some of the second group of control elements are those control elements that have, for a defined sub-set of the parameters, describing parameter values that are within a threshold of the describing parameter values of the target control element.

12. A command interface as claimed in claim 7, wherein at least some of the second group of control elements are those control elements that are most popular.

13. A command interface as claimed in claim 7, wherein at least some of the second group of control elements includes control elements that belong to clusters of control elements.

14. A command interface as claimed in claim 7, wherein at least some of the second group of control elements include a first control element representing a first clusters of multiple control elements and a second control element representing a second clusters of multiple control elements.

15. A command interface as claimed in claim in claim 1, wherein the second group of control elements represent candidate target control elements that become a target control element when actuated.

16. A command interface as claimed in claim 1, wherein a memory access command is created in response to actuation of a control element of the first group of control elements.

17. A command interface as claimed in claim 1, wherein the control elements are selectable icons on a computer display.

18. (canceled)

19. A command interface as claimed in claim 17, wherein the control elements give a visual indication of the values of the parameters for a data structure to which it is mapped.

20. (canceled)

21. A graphical user interface comprising:
a plurality of different control elements each of which generates a different control command when actuated by a user and each of which is mapped to a different data structure defining a three dimensional model having a shape, each control element being thereby associated with a shape, wherein
the plurality of control elements are arranged for actuation by a user and are categorized into different groups including:
a first group of control elements comprising control elements that are associated with shapes that are most similar, according to a first similarity criterion, to a shape specified by the user in a prior request, and
a second group of control elements comprising a first additional control element that is associated with a shape that is dissimilar, according to the first similarity criterion, to the shape specified by the user in the prior request, and that, when actuated by a user, specifies in a new request the shape associated with the first additional control element.

22. (canceled)

23. A method for controlling a machine comprising:
presenting a first group of control elements for actuation by a user and comprising control elements that are associated with shapes that are most similar, according to a first similarity criterion, to a target shape;
presenting a second group of control elements for actuation by a user and comprising a first additional control element that is associated with a shape that is dissimilar, according to the first similarity criterion, to the target shape;
detecting actuation of the first additional control element;
presenting a replacement first group of control elements for actuation by a user and comprising control elements that are associated with shapes that are most similar, according to the first similarity criterion, to a shape associated with the first additional control element; and
presenting a replacement second group of control elements for actuation by a user and comprising a replacement first additional control element that is associated with a shape that is dissimilar, according to the first similarity criterion, to the shape associated with the first additional control element.

24. A computer program comprising computer program instructions which when loaded into a processor enable the processor to perform the method of claim 23.
